(19) United States
(12) Patent Application Publication
(10) Pub. No.: US 2010/0206969 A1
(43) Pub. Date: Aug. 19, 2010

(54) Grinding Sink Strainer

(76) Inventor: Finn A. Strong, San Rafael, CA (US)

Correspondence Address: PATENT LAW OFFICES OF MICHAEL E. WOODS, 16 Hazel Ct., San Rafael, CA, 94901-5223, US

(21) Appl. No.: 12/705,967

(22) Filed: Feb. 15, 2010

Related U.S. Application Data
(60) Provisional application No. 61/207,686, filed on Feb. 14, 2009.

(51) Int. Cl. B02C 19/00; E03C 1/26

(52) U.S. Cl. 241/101.01; 4/292

(57) ABSTRACT

A sink drain strainer and sink straining method that does not require electricity or installation permitting a user to manually cut, grind, push, or punch clogging food debris through the drainage holes so that it will be small enough to safely pass through the plumbing system without causing clogs. A sink strainer for processing a solid organic debris object, includes a sink strainer basket, sized for overlying and covering a drain, the sink strainer basket including a plurality of drainage holes retaining the solid organic debris object and inhibiting the solid organic debris object from entering into the drain; and a manually-actuable debris processor, coupled to the basket, for interacting with the drainage holes to resize the solid organic debris object into smaller debris objects sized to enter into the drain from the basket.

### CROSS REFERENCE TO RELATED APPLICATIONS

This Application claims the benefit of U.S. Provisional Application 61/207,686 filed on Feb. 14, 2009.

### BACKGROUND OF THE INVENTION

This invention relates to sink drain strainers or sink drainage baskets, specifically to a sink drain strainer that reduces the clogging of plumbing systems with food debris.

Sink drain strainers or sink drainage baskets primary purpose is to catch any large debris that may clog the drainage pipes leading from the sink. The other purpose is to provide a plug or stop that can be lowered from the strainer so the user can fill the sink with water when desired. The problem with present sink drain strainers is they quickly clog with debris from a typical dishwashing. A piece of lettuce, a noodle, or soggy cereal is often enough to stop the flow of water through the strainer requiring the user to pull the messy, greasy, dripping basket out of the sink, walk to the trashcan and bang it on the side of the trashcan to clear it or even worse use their fingers to dredge the food debris from the sink drainage basket and carry it to the trashcan. This invention solves this frequent and messy problem.

A more complex and expensive solution to this problem is an electric garbage disposal. Electric garbage disposals solve the messy food debris problem but they are expensive to buy, require installation, require electricity, and are often not allowed in apartment buildings.

In conclusion, what is needed is a sink drain strainer that does not require electricity or installation, allowing the user to manually cut, grind, or push clogging food debris through the drainage holes so that it will be small enough to safely pass through the plumbing system without causing clogs.

### BRIEF SUMMARY OF THE INVENTION

Disclosed are sink drain strainers and sink straining methods that do not require electricity or installation permitting a user to manually cut, grind, push, or punch clogging food debris through the drainage holes so that it will be small enough to safely pass through the plumbing system without causing clogs. A sink strainer for processing a solid organic debris object, includes a sink strainer basket, sized for overlying and covering a drain, the sink strainer basket including a plurality of drainage holes retaining the solid organic debris object and inhibiting the solid organic debris object from entering into the drain; and a manually-actuable debris processor, coupled to the basket, for interacting with the drainage holes to resize the solid organic debris object into smaller debris objects sized to enter into the drain from the basket.

A solid organic debris object processing method, the method includes the steps of: (a) retaining the solid debris object in a sink strainer basket overlying a drain, the basket including a plurality of draining holes retaining the solid organic debris object and inhibiting the solid organic object from entering into the drain; and thereafter (b) actuating manually a debris process coupled to the basket to resize the solid organic debris object into smaller debris objects sized to enter into the drain from the basket.

Embodiments of the present invention include an improved sink drain strainer, having a manually rotating paddle that scrapes clogging debris against the drainage holes of the strainer basket. These drainage holes are designed to interact with the paddle (e.g., punching, rotating, or otherwise resizing) to cut or grind clogging debris into smaller pieces allowing them to pass through the drainage holes easily and thus safely through the attached plumbing system. This invention allows the user to simply actuate the paddle, manually, a few times to clear the clogging debris without having to remove the sink strainer to empty it or to dredge the debris out of the basket with their fingers. Embodiments also include a punch-and-cut strainer.

Accordingly, several objects and advantage of the present invention are: to provide a sink strainer with a simple and manual way to clear clogging food debris; to provide a way to remove clogging debris without having to remove the sink strainer for cleaning; to provide a sink strainer that reduces the mess to surrounding areas by not requiring the user to carry the sink strainer and dripping food debris to a trashcan; to provide a sink strainer that drains properly and won't succumb to constant clogging; to provide a sink strainer that won't be cast aside because of constant clogging thereby risking clogging pipes further down the pluming line with larger debris; to provide a vastly cheaper option to an electric garbage disposal; to provide a simpler solution, as far as installation is concerned, compared to an electric garbage disposal; to provide a drainage solution for already existing installed sink drains; to provide a grinding sink strainer that can be easily disassembled for cleaning; to provide a grinding sink strainer that snugly references the sink drain with either a reference ring or reference pads; and to provide a grinding sink strainer that has the option for a drain plug.

Further objects and advantages of the invention will become apparent from a consideration of the drawings and ensuing description.

### BRIEF DESCRIPTION OF THE DRAWINGS

FIG. 1 is a perspective top view of the grinding sink strainer showing the strainer basket with cutting drainage holes and a manually rotating grinding paddle;

FIG. 2 is a perspective angle view of the grinding sink strainer;

FIG. 3 is a perspective side view of the grinding sink strainer;

FIG. 4 is a lateral cross-sectional view of the grinding sink strainer positioned above a lateral cross-sectional view of a standard recessed sink drain collar;

FIG. 5 is a lateral cross-sectional view of the grinding sink strainer positioned inside a lateral cross-sectional view of a standard recessed sink drain collar showing how the two fit together;

FIG. 6 is a perspective top view of the grinding sink strainer with phantom dotted lines and arrows showing how the grinding paddle would spin;

FIG. 7 is a perspective side view of the grinding sink strainer showing how the grinding paddle could be removed for cleaning;

FIG. 8 is a lateral cross-sectional view of how the raised grinding/cutting edges would interact with the grinding paddle to cut large clogging debris into smaller non-clogging pieces;

FIG. 9 is a top view of corresponding parts from FIG. 8;

FIG. 10 is a lateral cross-sectional view of how the recessed grinding/cutting edges would interact with the grinding paddle to cut large clogging debris into smaller non-clogging pieces;

FIG. 11 is a top view of corresponding parts from FIG. 10;

FIG. 12 is a lateral cross-sectional view of how a flat grinding/cutting edge would interact with the grinding paddle to cut larger clogging debris into smaller non-clogging pieces;

FIG. 13 is a top view of corresponding parts from FIG. 12;

FIG. 14 is a perspective top view of a punch-and-cut sink strainer showing the strainer basket with cutting drainage holes and a manual punch paddle;

FIG. 15 is a perspective angle view of the punch-and-cut sink strainer of FIG. 14;

FIG. 16 is a perspective side view of the punch-and-cut sink strainer of FIG. 14;

FIG. 17 is a lateral cross-sectional view of the punch-and-cut sink strainer of FIG. 14 positioned above a lateral cross-sectional view of a standard recessed sink drain collar; and

FIG. 18 is a lateral cross-sectional view of the punch-and-cut sink strainer of FIG. 14 positioned inside a lateral cross-sectional view of a standard recessed sink drain collar showing how the two fit together.

### DETAILED DESCRIPTION OF THE INVENTION

The present invention relates to a method, system and apparatus for a sink drain strainer that does not require electricity or installation, allowing the user to manually cut, grind, push or punch clogging food debris through the drainage holes so that it will be small enough to safely pass through the plumbing system without causing clogs. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

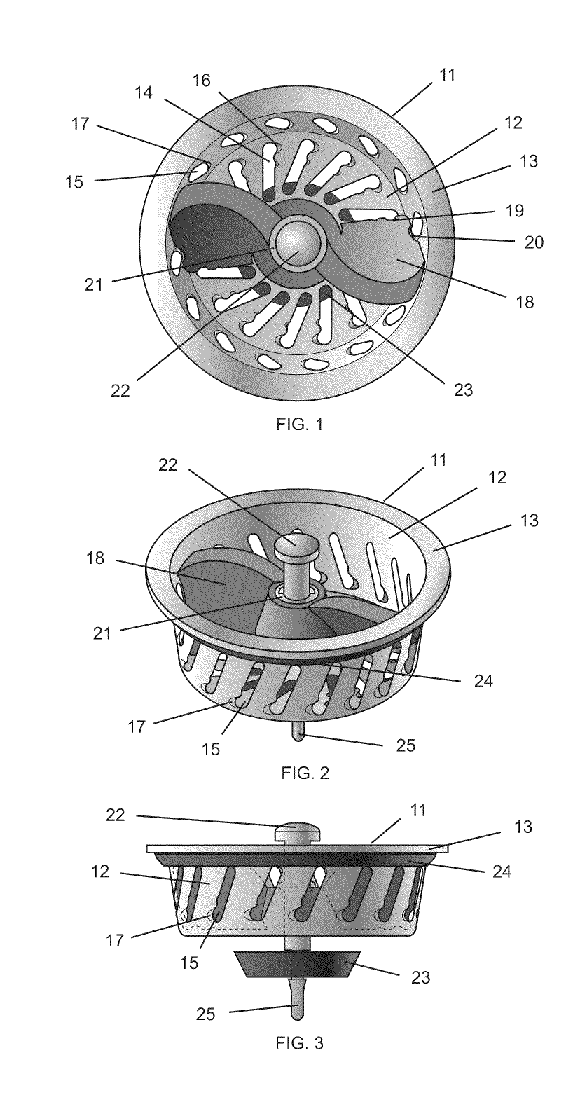

FIG. 1 is a top view of the grinding sink strainer 11 constructed in accordance with the invention. The round strainer basket 12 has a flared rim 13 and series of bottom drainage holes 14 and side-wall drainage holes 15. Each bottom drainage hole 14 has a raised grinding edge 16. Each side drainage hole 15 also has a raised grinding edge 17. Inside the strainer basket 12 is a rotating grinding paddle 18 with bottom recesses 19 and side recesses 20 to match the raised grinding edges 16 and 17. The plug handle 22 goes through the plug handle collar 21 and attaches to the drain plug 23.

FIG. 2 is a perspective view of the grinding sink strainer 11 showing the drainage basket 12 with flared rim 13, side drainage holes 15 with grinding edges 17 and bottom drainage holes 14 with grinding edges 16. A rubber (or other material) reference ring 24 is located under the flared rim 13 to secure the grinding sink strainer 11 properly in a standard recessed sink drain. The reference ring 24 (or possibly, reference pads) keeps the strainer basket from slipping in relation to the sink drain so that the grinding paddle 18 can rotate in relation to the strainer basket 12. Shown inside the drainage basket 12 is the grinding paddle 18. A collar 21 houses the plug handle 22 and together are the axis that the grinding paddle 18 rotates around. A reference pin 25 at the bottom of the plug handle 22 is used to properly seat the drain plug in the sink drain.

FIG. 3 is a side view of the grinding sink strainer 11 showing the drainage basket 12 with side drainage holes 15 with grinding edges 17. Placed under the strainers flared rim 13 is a rubber (or other material) reference ring 24. This reference ring 24 is for snugly securing the grinding sink strainer 11 in a standard recessed sink drain so that it does not move around while the operator manually rotates the grinding paddle 18. The plug handle 22 moves the rubber (or other material) drain plug 23 up or down to plug the sink drain. The reference pin 25 below the drain plug 23, references a standard sink drain to properly seat the drain plug 23 as well as the entire grinding sink strainer assembly 11 in a standard recessed sink drain.

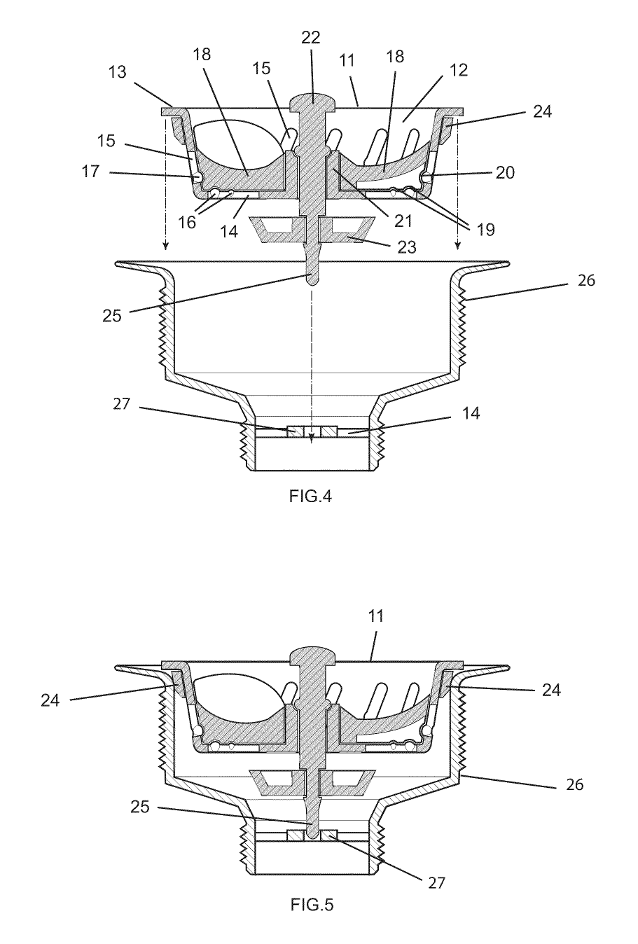

FIG. 4 is a side cross section view of the grinding sink strainer 11 situated above a side cross section view of a standard recessed sink drain 26 often found in a typical kitchen sink. In this view one can see how the grinding paddle 18 fits into the strainer basket 12 and around the plug handle collar 21 and plug handle 22. This view also shows how the bottom raised cutting/grinding edges 16 and side cutting/grinding edges 17 interact with the grinding paddle bottom recess 19 and grinding paddle side recess 20.

FIG. 5 is a side cross section view of the grinding sink strainer 11 seated properly inside of a side cross section view of a standard recessed sink drain 26. This view shows how the rubber reference ring 24 contacts the standard recessed sink drain 26 for a snug non-slipping fit. This also shows how the drain plug reference pin 25 fits into the strainer pin reference ring 27 on the standard recessed sink drain 26.

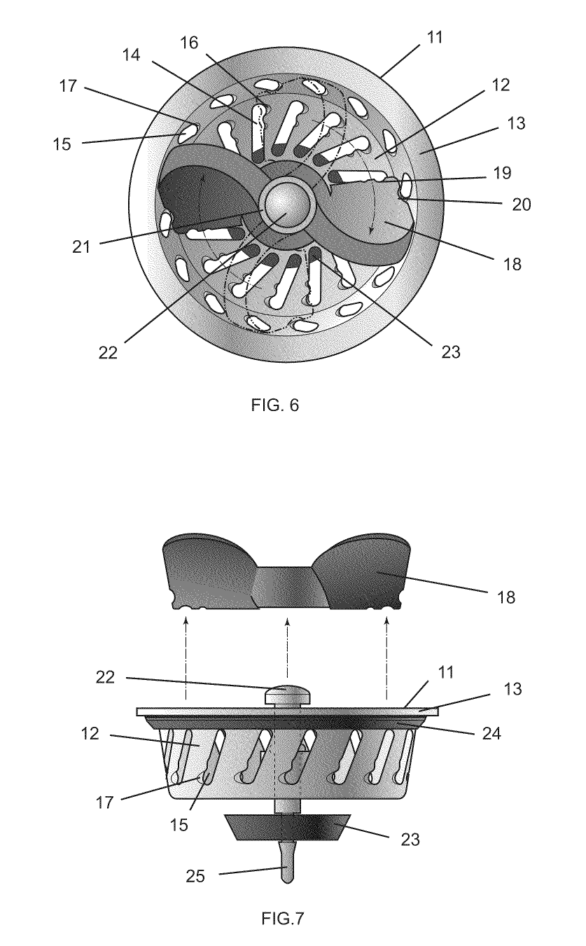

FIG. 6 shows how the grinding paddle 18 would manually rotate around the plug handle collar 21 and plug handle 22.

FIG. 7 is a side-view of the grinding sink strainer 11 showing how the grinding paddle 18 can be removed for easy cleaning.

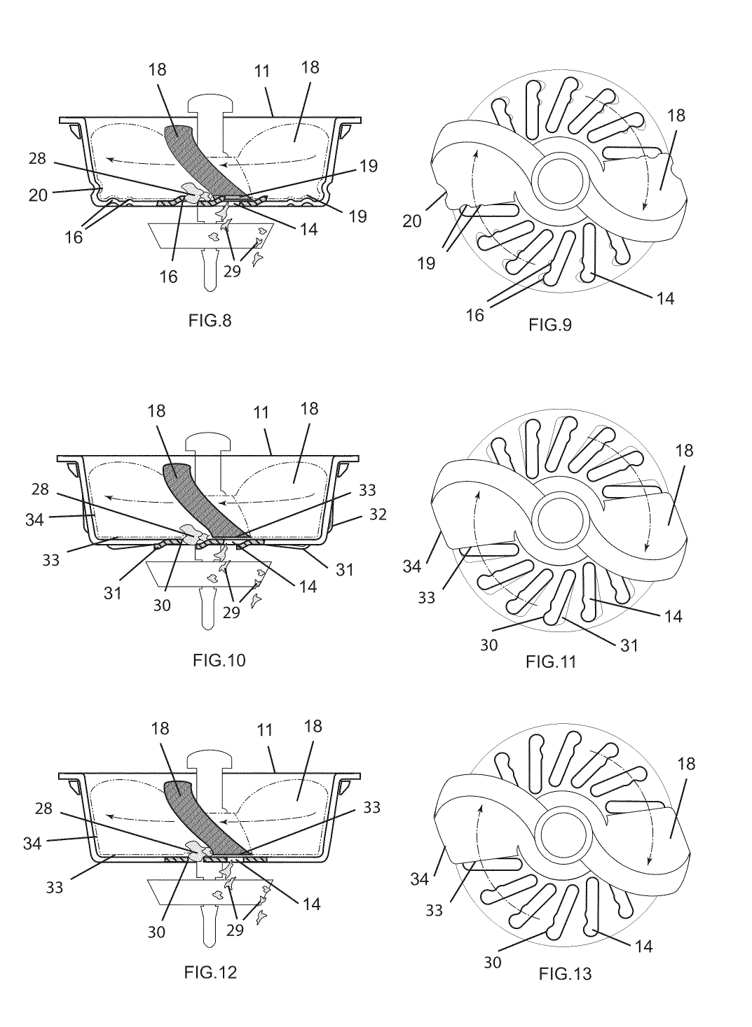

FIGS. 8-13 show various embodiments of the grinding sink strainer 11 with different grinding surfaces 19, 33 on the grinding paddle 18 and cutting edges 16, 30 on the drainage holes 14. The preferred embodiment is shown in FIG. 10.

FIG. 8 is a side view of the grinding sink strainer 11. This cross-section view highlights how the bottom raised cutting/grinding edges 16 interact with the bottom grinding paddle recesses 19 to cut clogging debris 28 into smaller pieces 29 so they can safely and easily pass through the bottom drain holes 14.

FIG. 9 is a top view (excluding side walls) of corresponding parts from FIG. 8

FIG. 10 is a side view of an alternate grinding sink strainer 11 with a flat bottom grinding surface 33 of the grinding paddle 18 and flat grinding/cutting edges 30 of the drainage holes 14 and a recessed leading edge 31 of drainage hole 14. This cross-section view highlights how the larger clogging debris 28 falls into the recessed edge 31 of drainage holes 14 and are held against the flat grinding/cutting edge 30 of the drainage holes 14 as the flat bottom grinding surface 33 of the grinding paddle 18 passes over to cut larger clogging debris 28 into smaller non-clogging pieces 29 which now pass through the drainage holes 14.

FIG. 11 is a top view (excluding side walls) of corresponding parts from FIG. 8

FIG. 12 is a side view of an alternate grinding sink strainer 11 with a flat bottom grinding surface 33 of the grinding paddle 18 and flat grinding/cutting edges 30 of the drainage holes 14 and without a recessed edge 31 as in FIG. 10. This cross-section view highlights how the flat cutting/grinding edge 30 interacts with the flat bottom grinding surface 33 of the grinding paddle 18 to cut larger clogging debris 28 into smaller non-clogging pieces 29 so they can pass through drain holes 14.

FIG. 13 is a top view (excluding side walls) of corresponding parts from FIG. 8

Operation

In operation one uses the grinding sink strainer 11 in standard recessed sink drain 26 similar to a standard sink strainer. The user can, when necessary, unclog the strainer basket 12 simply by rotating the grinding paddle 18 to cut, grind, or push clogging debris 28 through the drain holes 14 so that the water in the sink can drain properly without having to remove the sink strainer. Water pressure from the clogged debris or running water from the sink in combination with the rotating grinding paddle 18 and cutting edges 16, 30 of the draining holes flush the small debris 29 through the drainage holes 14.

Reasons the grinding sink strainer is an improvement over a standard sink strainer include the following: The grinding sink strainer seldom has to be removed from sink; The user seldom has to carry a dripping, dirty strainer to a place of disposal thus reducing the need for having to wipe-up the floor or surrounding area; The user does not have to remove greasy, wet debris with their fingers every time the strainer gets clogged; By easily keeping the drain free of clogging debris, the objects in the sink will not soak in the backed up, often dirty, greasy, water thus requiring less cleaning; Often regular strainers are cast aside because of their frequent clogging problems thus allowing larger debris to go down the drain possibly causing the pluming to clog further down the line.

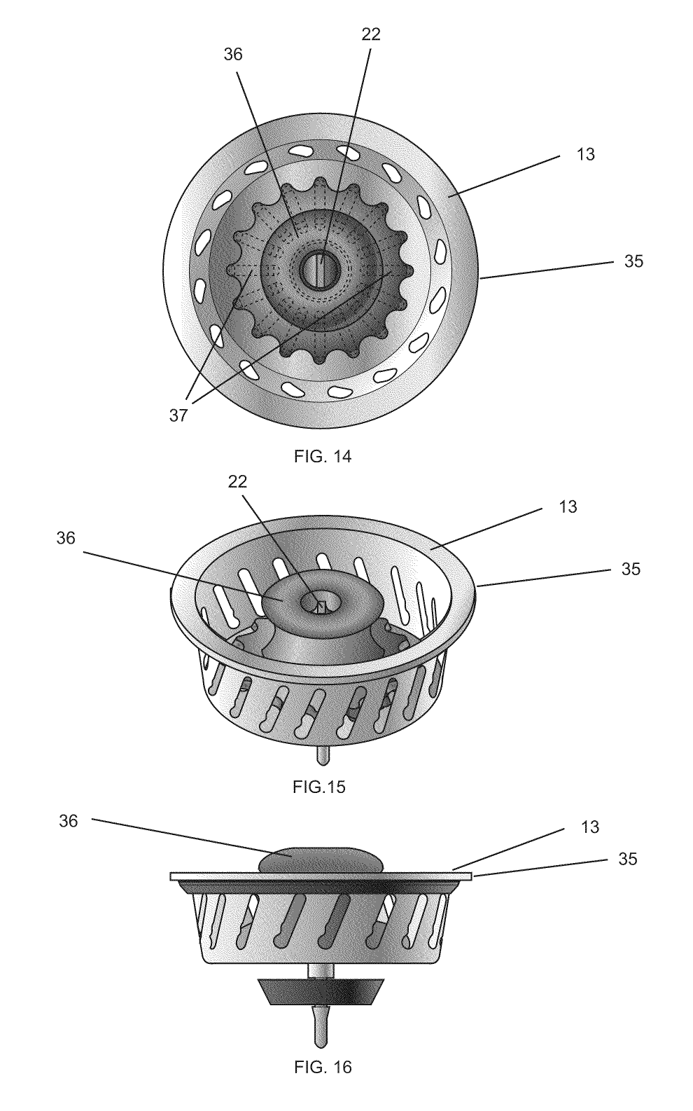

Punch-and-Cut Embodiment: FIG. 14-FIG. 18

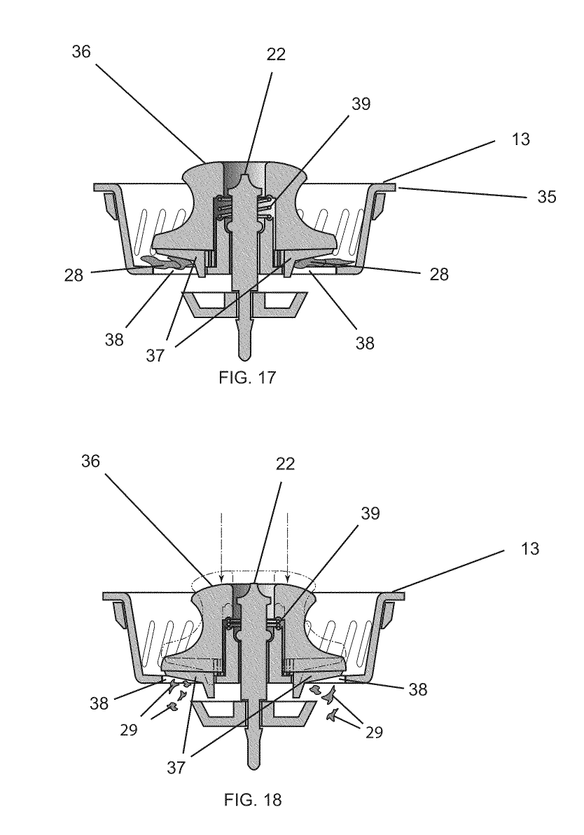

FIG. 14 is a perspective top view of a punch-and-cut sink strainer showing the strainer basket with cutting drainage holes and a manual punch paddle; FIG. 15 is a perspective angle view of the punch-and-cut sink strainer of FIG. 14; FIG. 16 is a perspective side view of the punch-and-cut sink strainer of FIG. 14; FIG. 17 is a lateral cross-sectional view of the punch-and-cut sink strainer of FIG. 14 positioned above a lateral cross-sectional view of a standard recessed sink drain collar; and FIG. 18 is a lateral cross-sectional view of the punch-and-cut sink strainer of FIG. 14 positioned inside a lateral cross-sectional view of a standard recessed sink drain collar showing how the two fit together. Alternate preferred embodiments of the present invention include an improved embodiment of the sink strainer, has a punch pad body 36 with a series of protruding punch cutters 37 that correspond with the bottom drainage holes 38 of the strainer basket. A spring 39 is inside of the punch pad body 36.

To operate, the user pushes down on the punch pad body 36, compressing the spring 39 and punching the protruding punch cutters 37 through the drainage holes 38. The drainage holes are designed to interact with the protruding nubs 37 to cut and dice larger clogging debris 28 into smaller pieces 29 allowing them to flush safely and easily through the attached pluming system. This invention allows the user to simply push down on the plunger punch pad body 36 to clear the clogging debris 28 without having to remove the sink strainer. When the user releases the punch pad body 36 the spring 39 decompresses and returns the punch pad body 36 to its resting position, allowing the water to flow through the drain holes 38 again.

### REFERENCE NUMERALS

11 grinding sink strainer
12 sink strainer basket
13 flared rim of basket
14 bottom drain holes
15 side drain holes
16 bottom raised grinding edge
17 side raised grinding edge
18 grinding paddle
19 bottom grinding paddle recess
20 side grinding paddle recess

021 plug handle collar
22 plug handle
23 drain plug
24 sink drain reference ring
25 drain plug reference pin
26 standard recessed sink drain
27 strainer pin reference ring
28 clogging debris
29 small non-clogging debris
30 bottom flat grinding edge of drainage hole
31 bottom recessed edge of drainage hole
32 side recessed edge of drainage hole
33 flat bottom surface of grinding paddle
34 flat side surface of grinding paddle
35 punch and cut sink strainer
36 punch pad body
37 protruding punch cutters
38 corresponding drain holes; and
39 spring

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims

What is claimed as new and desired to be protected by Letters Patent of the United States is:

1. A sink strainer for processing a solid organic debris object, comprising:
a sink strainer basket, sized for overlying and covering a drain, said sink strainer basket including a plurality of drainage holes retaining the solid organic debris object and inhibiting the solid organic debris object from entering into said drain; and
a manually-actuable debris processor, coupled to said basket, for interacting with said drainage holes to resize the solid organic debris object into smaller debris objects sized to enter into said drain from said basket.

2. The sink strainer of claim 1 wherein said debris processor includes a rotational cutter and a handle for safely rotating said rotational cutter wherein a rotation of said rotational cutter cuts said solid organic debris object to resize it.

3. The sink strainer of claim 1 wherein said debris processor includes a reciprocating punch and a handle for safely punching said reciprocating punch wherein a reciprocation of said reciprocating punch cuts said solid organic debris object to resize it.

4. A solid organic debris object processing method, the method comprising the steps of:
(a) retaining the solid debris object in a sink strainer basket overlying a drain, said basket including a plurality of draining holes retaining the solid organic debris object and inhibiting the solid organic object from entering into said drain; and thereafter
(b) actuating manually a debris process coupled to said basket to resize the solid organic debris object into smaller debris objects sized to enter into said drain from said basket.

5. The debris object processing method of claim 4 wherein said debris processor includes a rotational cutter and a handle for safely rotating said rotational cutter and wherein said actuating step (b) includes rotating said rotational cutter to cut said solid organic debris object to resize it.

6. The debris object processing method of claim 4 wherein said debris processor includes a reciprocating punch and a handle for safely punching said reciprocating punch and wherein said actuating step (b) includes reciprocating said reciprocating punch to cut said solid organic debris object to resize it.
